(19) United States
(12) Patent Application Publication
(10) Pub. No.: US 2009/0224924 A1
(43) Pub. Date: Sep. 10, 2009

(54) SYSTEM AND METHOD FOR POSITIVELY REINFORCING HAND-HYGEINE COMPLIANCE

(76) Inventor: Robert B. Thorp, Phoenix, AZ (US)

Correspondence Address: VENABLE, CAMPILLO, LOGAN & MEANEY, P.C., 1938 E. OSBORN RD, PHOENIX, AZ, 85016-7234, US

(21) Appl. No.: 12/165,734

(22) Filed: Jul. 1, 2008

Related U.S. Application Data
(60) Provisional application No. 61/068,746, filed on Mar. 10, 2008.

(51) Int. Cl. G08B 23/00

(52) U.S. Cl. 340/573.1

(57) ABSTRACT

A system and method for increasing customer safety by directly involving customers and reminding and rewarding workers of hand decontamination compliance issues within a facility to include a plurality of positive-reinforcement hand-hygiene stations; stations that provide a conveniently-located choice of hand-hygiene products such as soap or lotion; personnel identification tags for workers in the facility; readers at the hand-hygiene stations capable of detecting the presence of worker identification tags; a controller for detecting whether a worker tag accessed a hand decontamination station; devices to visually and audibly prompt and/or educate a worker or customer in the use of the hand wash station; a device to give a visual and audible reward for using a station; a device to issue rewards; and a plurality of computers to manage the system.

### CROSS-REFERENCE TO RELATED APPLICATIONS

This non-provisional application claims benefit of U.S. Provisional Patent Application Ser. No. 61/068,746 filed Mar. 10, 2008.

### BACKGROUND OF THE INVENTION

1. Field of the Invention

The present invention relates to infection-reduction systems for use in the field of health-care and other hygiene critical fields, and more particularly to an automated positive-reinforcement hand-hygiene station that increases customer safety and hand-hygiene compliance while decreasing contact infections.

2. Discussion of the Related Art

As many as 2.4 million Americans will acquire a nosocomial (hospital acquired) or food-borne infection and 100,000 persons will die as a result of such infections primarily due to poor hand-hygiene compliance and transferred organisms. Hand-hygiene compliance can be as low as 40% in some institutions.

Bacterial infections, including Nosocomial infections, are prevalent in all service facilities including hospitals, nursing homes, meat packing plants, and grocery stores to name a few. In the hospital setting, these infections can pose a significant health risk to hospitalized patients by delaying healing, extending the length of hospitalization and increasing the cost of care. Research reveals that several types of microorganisms can be transferred by hand to live hosts, thereby producing infections.

Hand-hygiene is the most important method of infection control. Failure to carry out hand-hygiene after toileting or prior to contact with a patient places patients and health care workers at greater risk for the development of nosocomial infections.

While workers play a key role in reducing infections, they have also been implicated in contributing to their increase by failing to perform hand decontamination prior to contact with a food item or patient and after handling contaminated items. Although health care workers are required to participate in annual infection control programs, there is a discrepancy between classroom knowledge of patient safety and applied knowledge of infection control. This discrepancy suggests that innovative strategies in infection control must be invented in order to reduce the rate of contact infections and increase customer safety.

Compliance programs in the art focus on “why” service workers should wash their hands before providing service. Alcohol dispensers have focused on the “how.” Compliance systems known in the art, however, use negative reinforcement techniques in an attempt to improve hand-hygiene compliance. The devices and systems known in the art use negative reinforcement by either tagging a person as “unclean,” penalize a person for non-compliance, or initiate a combination of the two. In addition, these systems and devices produce an invasive experience due to their capability of tracking a worker or service provider's every move.

U.S. Pat. No. 6,975,231 discloses a hand-hygiene monitoring system that uses sensors attached to hand wash dispensers, sinks, doors, and a patient care area. The system then determines if a worker has used a hand wash station before entering the patient care area. If a station has not been used, the worker is warned and compliance data is recorded.

U.S. Pat. No. 6,392,546 discloses a portable, individualized, hand-hygiene agent dispenser which is filled and checked out from a control station to healthcare workers and worn by the workers outside their clothing. This dispenser, when activated, is sensed by the system and data is recorded. Again, if the worker enters a customer or patient area without activating the dispenser, a warning is generated and compliance data is recorded.

U.S. Pat. No. 5,945,910 discloses a hand-hygiene and monitoring system that uses a sensor that signals the dispenser. A dual mode monitoring and reporting module includes an input element, an output element, a processor and memory. The module accepts data identifying a worker, receives a signal indicating use of the cleaning agent and stores the compliance data records.

U.S. Pat. No. 5,870,015 discloses an apparatus in which toilet use is monitored and audible signals are produced that instruct users in how to use the toilet and perform hand-hygiene. The apparatus includes a housing that is attached to the toilet but is mobile. A switch arm is attached to the toilet handle and sends an activity signal indicating the switch arm position which activates electronic circuitry and audible messages.

U.S. Pat. No. 5,812,059 discloses a basic method and system for improving hand-hygiene. An activating device is located outside a work area, a hand cleaning station is located near the work area, and a deactivating device is associated with the hand cleaning station. Upon leaving a food handling area, an identification device worn by a worker is activated when the worker is near the device. The indicator is deactivated only when the device has sensed that the worker has used the hand cleaning station.

U.S. Pat. No. 5,202,666 discloses an automated device used to remind workers to wash their hands after using the toilet. Sensors are worn on credit card-sized badges and mounted in bathroom ceilings, attached to soap dispensers and sinks. When a worker enters the bathroom, the ceiling unit sensor activates a blinking light on the badge. The light is deactivated only after the worker pumps the soap dispenser and stands in front of the sink for at least fifteen seconds.

U.S. Pat. No. 4,986,144 discloses a hand-hygiene warning system designed to warn someone to wash their hands. A door activated system is armed when the door to the wash facility is opened or a toilet is flushed. It is only deactivated when it is determined that the person has washed their hands.

However, these existing systems have several problems associated with them. None of the systems mentioned directly involve the customer or patient in the hand-hygiene compliance program or system, an added assurance that has already been proven effective in improving customer safety in many hospital settings. Also, none of the mentioned systems address the issue of locating all hand-hygiene products in one convenient location so that workers can wash their hands and apply lotion at the same location. In addition, the above mentioned systems stifle the workers freedom to choose whether or not to actively participate in hand-hygiene by being forced to comply. This forceful action further increases non-compliance and subversion of existing systems.

In many service environments, employees may tolerate security cameras due to their ability to increase security. However, current compliance systems known in the art track a person's every move, continually beeping at the worker or cueing the worker to wash their hands. Subsequently an annoyance is created when the service provider is in range of the tracking system but does not have the necessity to wash their hands. For example, if a nurse is answering a patient's call light and the person only asks for the pitcher of water to be refilled, there is no need for the nurse to wash their hands. Regarding such a scenario, the current systems in the art will still tag them “unclean” and possibly prompt them endlessly until they use a dispenser. In time, this will become overwhelming or a nuisance to the worker. Historically, workers then subvert the system instead of supporting it.

There is no effective way to force employees to wash their hands. If forced, it creates worker-resentment through the use of negative reinforcement and inevitable subversion of the system.

### SUMMARY OF THE DESCRIPTION

The invention is summarized below only for purposes of introducing embodiments of the invention. The ultimate scope of the invention is to be limited only to the claims that follow the specification.

The invention is incorporated in a system and method for reducing infection in the field of health care or other hygiene critical fields (such as restaurants or grocery stores, for example). Generally, the infection-reduction system uses a hand-hygiene station that can (1) identify when it is being used (i.e., “a hand-hygiene identification system”), (2) identify the employees using it (i.e., “an employee-identification system”), and (3) associate a reward with the employee (i.e., a “reward system”). In operation, the employee-identification system preferably activates only after the hand-hygiene identification system indicates that hands are being washed by an employee. The reward system then assigns a reward to the employee who used the hand-hygiene station. In this way, the system positively reinforces hand-hygiene through a reward system and improves hand-hygiene compliance. This is accomplished by using techniques and a device that will decrease infections better than negative reinforcement systems.

In addition, the hand-hygiene station can employ personalized visual and audible reminders as a person passes the station. Such a person can be encouraged to wash their hands but are not forced to comply. For example, if the service provider (employee) does not have a true need to wash his or her hands, no annoyance is created and the person maintains their ability to choose and, more importantly, adapt to the unique circumstances at that moment. When the hand-hygiene station is used, a visual and audible commendation can be given, positively reinforcing the action. In addition, the system, in an automated way, can issue rewards for short-term and long-term hand-hygiene compliance. Data can be stored and analyzed by Compliance Officers through the computer uplink capability.

In addition, the hand-hygiene station can incorporate the involvement of others in the issue of hand-hygiene compliance. When a device is installed, for example, in the direct line of sight of a patient in a hospital, the patient can determine if hand-hygiene has occurred before care is initiated on them personally. Further, the system can teach the patient, through a colorful, educational display, how and why to ask if hand-hygiene has occurred, directly involving the patient in their own care and providing a method of ensuring compliance. Coupled with patient education upon admittance into the healthcare facility, the system can add an additional mechanism of compliance by teaching the patient or customer to insist the healthcare worker comply with hand-hygiene.

In addition, the hand-hygiene station can add the ability to provide a plurality of hygiene products that include lotion in one convenient location. Workers no longer need suffer from dry, cracked hands due to chronic use of alcohol-based cleansers or spend additional time hunting for lotion dispensers often located in other areas of the work zone.

Through positive reinforcement, mentioned above, a worker practices good habits that they become eager to comply with. It literally can become monetarily valuable to them as well as valuable for safe patient care. Through the hand-hygiene station, a service worker can look forward to receiving a well earned reward for their efforts to comply. Patients and customers will help ensure compliance. Compliance rates will rise, infection rates will fall, and employees will feel they still have a choice, further reinforcing the positive action.

### BRIEF DESCRIPTION OF THE DRAWINGS

This invention will be described in detail with reference to the accompanying drawings wherein:

FIG. 1 is an illustration of a patient room with a nurse using an embodiment of a hand-hygiene station in the patient's line-of-sight with the nurse receiving positive commendation from the device.

FIG. 2 is an illustration of a preferred embodiment of the hand-hygiene station.

FIG. 3 is an elevation-view of a preferred embodiment of the hand-hygiene station illustrating the preferred ability of the invention's touch-screen capability and paper reward printing capability.

FIG. 4 is an illustration of a preferred embodiment of the hand-hygiene station demonstrating the preferred removal and insertion of a plurality of dispensing bottles and their electronic contacts.

FIG. 5 is an illustration of a preferred embodiment of the back of the hand-hygiene station.

FIG. 6 is an illustration of a preferred embodiment of the bottom of the hand-hygiene station with dispensing bottles in place.

FIGS. 7, 8, 9, 10, 11 and 12 are illustrations of a preferred embodiment of the system of commendation, positive reinforcement and patient/customer education through the use of visual graphics that are displayed on the screen of the invention and the issuing of rewards.

FIG. 13 is an elevation-view of the front of a preferred embodiment of a dispensing bottle.

FIG. 14 is an elevation-view of a preferred embodiment of the back of a dispensing bottle.

FIG. 15 is an elevation-view of an alternative embodiment of a dispensing bottle.

FIG. 16 is a top view of the dispensing bottle shown in FIG. 13.

FIG. 17 is a bottom view of the dispensing bottle shown in FIG. 13.

FIG. 18 is a left side view of the dispensing bottle shown in FIG. 13.

FIG. 19 is a right side view of the dispensing bottle shown in FIG. 13.

FIG. 20 is a flowchart illustrating the preferred process steps for FIGS. 1, 3, 7, 8, 9, 10, 11 and 12.

FIG. 21 is a flowchart illustrating an alternate embodiment of the process steps for FIGS. 7, 8, 9, 10, 11 and 12.

### DESCRIPTIONS OF EMBODIMENTS

It is to be understood that the descriptions below are merely illustrative of the presently preferred embodiments of the invention and that no limitations are intended to the detail of construction or design herein shown other than as defined in the appended claims.

For the purposes of this invention, the term “hand-hygiene station” refers to a device that can do one or more of the following: automatically manage employee identification, dispense hand hygiene products, issue rewards, and/or involve an observer, such as a patient or employee, visually and audibly, in an educational or purposeful way. The term “infection-reduction system” refers to a system that can reduce the transmission and amount of infectious organisms. The term “hand-washing identification system” refers to a system that automatically records use of the “hand hygiene station.” The term “employee identification system” refers to a system that automatically detects the identity of the person using the “hand hygiene station” through the use of devices known in the art. The term “reward system” refers to a system that can do one or more of the following: tracking and determining whether a person qualifies for a reward, issuing a reward visually, audibly or by a tangible item, and/or tracking statistics related to the frequency of issued rewards.

The systems described herein are referred to as an infection-reduction system (or the “system”) as this combination of terms best describes the intended and preferred use of each embodiment described below. For ease of description, the system generally comprises a hand-hygiene station 200, the hand-hygiene station 200 comprising a hand-hygiene identification system, an employee-identification system, and a reward system, wherein the employee-identification system activates only after the hand-hygiene identification system indicates that hands are being treated by an employee and wherein the reward system assigns a reward to the hand-washing employee.

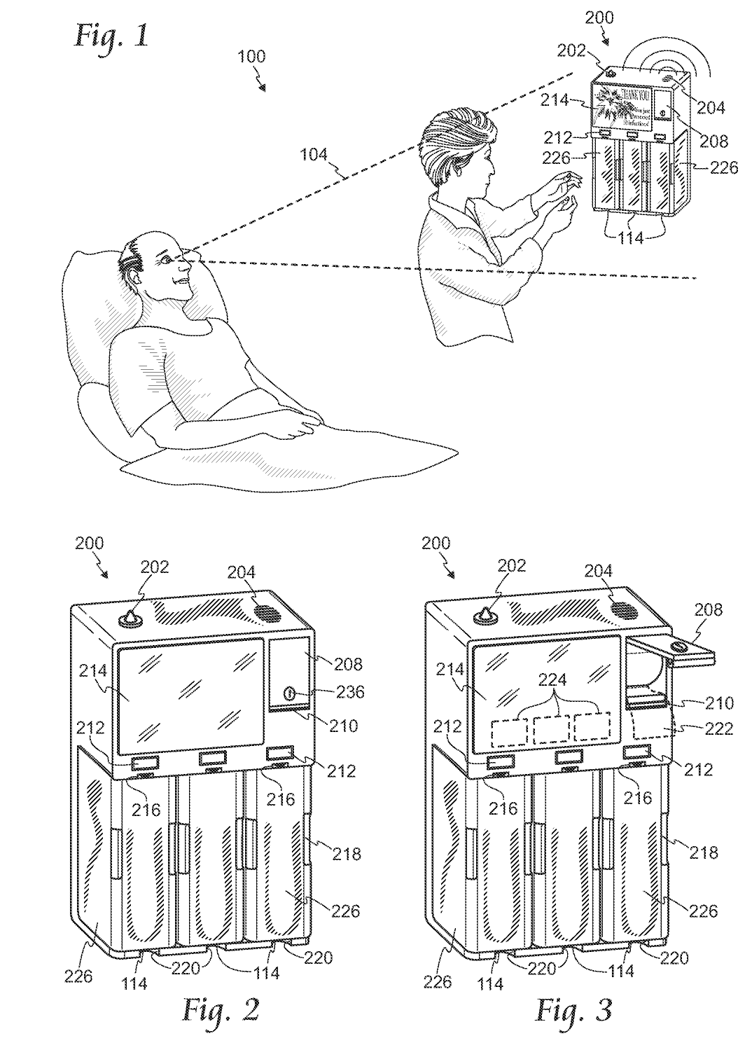

FIG. 1 illustrates a preferred embodiment of the system and method. FIG. 1 shows a patient room 100 and a hand-hygiene station 200, which can be attached to a wall, a mobile pole, or other convenient location. As shown, a nurse has approached the hand-hygiene station 200. The worker then activates a passive infrared motion (PIR)/thermal detector 114 to dispense a hand wash product. Upon activation of the hand wash product, the hand-hygiene station 200 senses a worker identification device known in the art such as an electronic name badge or badge holder, which positively identifies the worker. In the event of a power outage, a button 212 may be pushed to activate the hand wash product bottle 226.

In another embodiment, the hand wash product bottle 226 can be a wet towel dispenser so as to provide a worker with a hand-hygiene product that works with their unique body chemistry and prevents cracking and drying of their hands, all located in one convenient location further described in FIG. 15.

In a preferred embodiment, the hand wash product bottles 226 or wet towel dispensers 226, will have a mechanism of locking the dispenser into the hand-hygiene station 200 making contact with electronic contacts which provide electronic communication between the hand-hygiene station 200 and the product bottle 226.

In a preferred embodiment, an infrared motion detector 114 is a detector that detects time variations and differences in temperature in multiple directions in the detectors field of view. The device detects the energy radiated by objects, such as a hand, in their vicinity, but do not emit any radiation. When the infrared motion detector 114 detects motion, a signal is sent indicating the detector's new state and a unique address is generated. The hand-hygiene product bottles 226 preferably contain a transmitter that transmits their unique address and a signal indicating an “on” status when their terminals are closed and a signal indicating an “off” status when the terminals are opened. The hand-hygiene station 200 detects the signal and transmits it to a computer via any well known communication method. The hand-hygiene station 200 can then determine which switch changed state, and the new state as well. Thus the hand-hygiene station 200 and hand wash product bottles 226 can produce a plurality of signals such as a signal to determine which product bottle 226 was used, how much product remains in the bottle, or a “refill now” signal that can be sent directly to a Resources Department or other maintenance department. The infrared signals can additionally be used to generate compliance and cost data. It should be understood that the uses of the infrared signals produced by the infrared devices 114 are not limited to those mentioned above.

In response to the action of using the station, an audible positive reinforcement message can be produced by the speaker/appliance device 204 positively reinforcing the action. The invention's screen 214 can also displays a visual positive-reinforcement message in response to the use of the hand-hygiene station 200. In response to the use of the hand-hygiene station 200, the paper reward printing device 208 can print and eject a reward such as a free lunch ticket. Alternatively, the hand-hygiene station 200 can send the reward information to a database for later use.

In the preferred embodiment, the customer, or patient as shown 100, will visually 104 observe the action of the worker washing their hands 100, directly involving the customer in hand-hygiene compliance. Coupled with prior admission education, the visual display 214 and audible signal 204 can instruct the customer or patient to ask if the worker has washed their hands before initiating care, directly involving the customer in the hand-hygiene compliance program.

In a preferred embodiment, it should be understood that a plurality of visual graphical displays 214 and audible signals 204, either educational, entertaining, or in the form of a positively-reinforcing commendation can be employed. In addition, it should be understood that any well known communications system or method can be used to produce the visual 214 and audible 204 signals.

In a preferred embodiment, it should also be understood that a plurality of visual graphical displays 214 and audible signals 204 can be produced either while the hand-hygiene station 200 is in use, while a reward is being printed and ejected by the reward device 208, or while in an idle mode.

It is preferred to use at least one computer to employ the present invention. The computer receives and processes data from all hand-hygiene stations 200 and can be located within a remote administrator's office. On the other hand, additional computers and communications devices may be used to connect remote locations within large complexes such as a multi-floor hospital. In this case, the additional computers are installed in separate locations from the first computer. Each computer, then, can independently process data collected from each hand-hygiene station 200.

The hand-hygiene station 200 can be linked to a computer system via a standard communications connection such as RS-232 or CAT-5 cabling. In a preferred embodiment, the hand-hygiene station 200 will be linked to a computer system by wireless communications 202. Usage data generated by the station 200 and product bottles 226 can be sent wirelessly by the communications device 202 to a computer data base. It should be understood that any well known communications system or method can be used to produce and transmit the signals between the hand-hygiene station 200 and a computer data base.

In addition, the wireless communications device 202 can initiate an identification signal that identifies a worker in range of the hand-hygiene station 200 by receiving a return-signal from a name badge, badge holder, or other well known personal identification device. Once a worker has been positively identified by the ID device 202, the hand-hygiene station 200 will personalize the visual display 214 messages and audible signals 204 to the worker by using the name of the worker in the displays 214 and audible signals 204.

In the preferred embodiment, it should be understood that rewards printed by the printing device 208 can be personalized, bar coded, and/or validated for the worker by positively identifying the worker through the ID device 202 or can be sent to the computer system.

FIG. 2 is a detailed elevation-view of an embodiment of the hand-hygiene station 200. The station 200 may consist of at least one visual screen 214, one audible device 204, a printing device 208 or a plurality of devices 208 for administering/ejecting 210 an immediate tangible reward such as a lunch ticket, a means of locking the reward dispenser 236, hand-hygiene product dispensers 226, means with which to grasp the product dispensers 218, a means with which to release the product dispenser 226 in the form of a release tab or button 216, and a communications device 202 creating a means of identification and communication between infrared devices 114, computers, and well known personal ID devices. Grooves 220 allow for the hand-hygiene product to be dispensed from the bottom of the dispensing bottles 226. It should be understood that the invention is not limited to this configuration but can be arranged in a plurality of configurations that facilitate ease of use.

The hand-hygiene station 200 can be fitted with a plurality of reward dispensers 208. The dispensers 208 can be secured with a well known locking mechanism 236. The dispensing bottles 226 can also be locked into place with a well known locking mechanism such as a push-and-release button mechanism 216. The station 200 can sense that the release button 216 has been pushed and initiate dispenser 226 instructions and generate a signal that can be sent wirelessly 202 to a computer indicating the dispenser bottle 226 has been changed.

FIG. 3 is a detailed elevation-view of a hand wash station 200 illustrating the station's electronic means of issuing visual 214, audible 204, and tangible rewards 222 and commendations. In the event that a reward is to be issued, the hand-hygiene station 200 may have at least one visual screen 214 that is touch-screen capable. This will allow for multiple “hot-spots” to be activated allowing the worker to make choices as to which reward they want. The touch-screen 224 capability will also facilitate programming of the station 200 and other maintenance options.

In a preferred embodiment, the reward dispenser 208 is of the type that accepts a roll of either blank or pre-printed paper. The pre-printed paper can then be validated before being ejected 210 as a printed reward 222. The dispensing device 208 may only allow a validated reward to be dispensed upon validation that a worker has qualified for the reward and may prevent forcible removable with a tension device. It should be understood that a plurality of reward dispensers or devices can be employed in this invention.

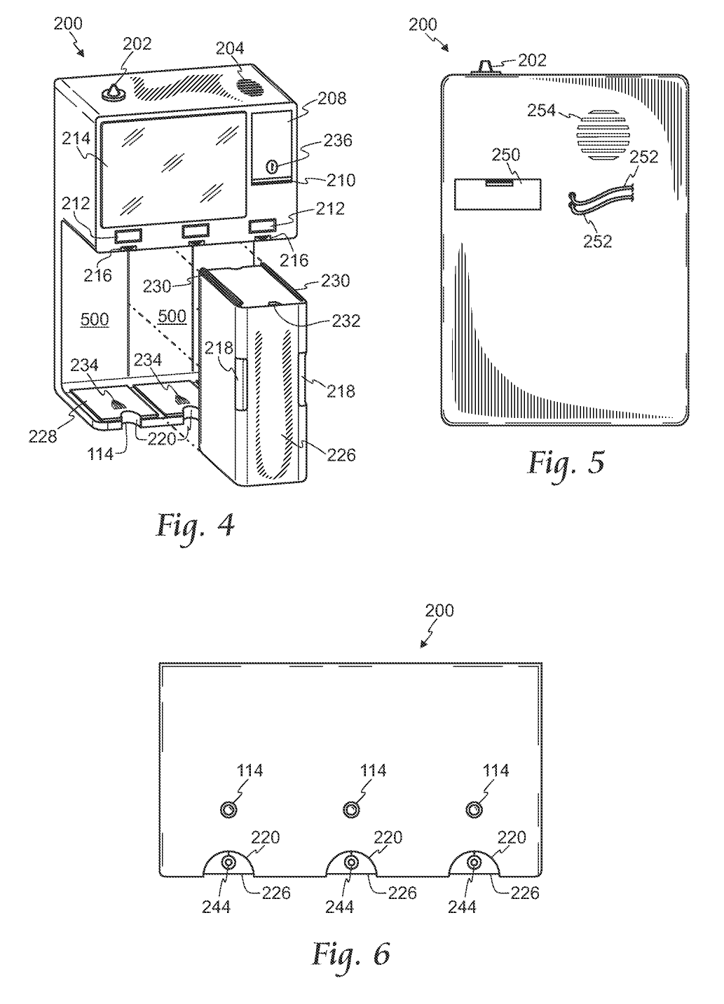

FIG. 4 is an elevated-view of the preferred hand-hygiene station 200 illustrating the removal of hand-hygiene dispensing bottles 226 and their related electronic contacts 234 on the station 200 within bays 500. The station 200 may have grooved plates 228 that allow a product dispensing bottle 226 to be inserted only one way and provide firm contact with the electronic plates 234 and fit appropriately within the bottle's 226 bay 500. Grooves 230 on the dispensing bottle 226 fit into the grooves of the plates 228 on the station 200. When an empty dispensing bottle 226 is to be changed with a full one, the dispensing bottle can be grasped by grooves 218 with one hand, while a release button 212 is pushed, releasing a knob from the locking groove 232 allowing the bottle to be removed from its bay 500. It should be known that a plurality of locking systems can be used to keep dispensing bottles 226 in place within their bay 500. Dispensing bottles may be designed to be recyclable or refillable.

In the preferred embodiment, the hand-hygiene station 200, as shown 200, has three bays 500 in which to maintain dispensing bottles 226. Yet, it should be known that a plurality of bays 500 can be employed in this invention in order to provide adequate choice of hand-hygiene products for the workers to use at one station 200.

FIG. 5 is a back view of the preferred embodiment of the hand-hygiene station 200. The station 200 may have at least one battery backup system 250, a vented port 254 for air flow, and a means for powering the unit by public utility electricity through a well known means such as wiring 252. In addition, the wiring 252 may consist of a RS-232 or CAT-5 to hard wire the unit into a computer network.

In a preferred embodiment, the hand-hygiene station 200 may be protected by a battery backup system 250 wired directly to the electronics of the station 200. In the event of a power failure, the battery backup system 250 will provide electricity to power the station 200 for a predetermined amount of time. If the battery power 250 is depleted, the station 200 will have the capability of releasing functionality so that the hand wash products can be dispensed manually by pressing a button as illustrated in FIG. 4, 212.

In a preferred embodiment, data is collected and files are edited via a dedicated telephone line 252 in communication with a centrally located computer in another location. A hand wash station 200 may communicate with the computer at an alternate central location so as to allow remote data collection from the hand wash station 200 and the editing of files without physically being present at the facility. On the other hand, data may be collected and files edited on site.

FIG. 6 illustrates the bottom of and preferred embodiment of the hand-hygiene station 200 and the location of the infrared sensors 114. In a preferred embodiment, the infrared sensors are strategically placed so that a worker's hand can be placed beneath the station 200 and beneath the desired dispensing bottle 226 and automatically receive a hand wash product through the dispensing nozzle 244. The infrared detector senses a workers hand beneath the detector which then sends a “on” signal to the hand wash station 200. The hand wash station 200 then sends a “dispense” signal to the dispensing bottle 226 which dispenses the desired product. After the infrared sensor 114 detects the presence of a workers hand, all other IR sensors 114 are immediately switched to the “off” position for a predetermined amount of time preventing multiple bottles 226 from dispensing all at once. If a worker's hand is removed from beneath an IR sensor 114, the IR sensor immediately resets to the “off” position. In addition, when a hand wash product is dispensed, compliance data is generated and recorded.

It should be understood that the hand wash station 200 may contain a plurality of dispensing capabilities including a manual mechanism for dispensing hand wash products.

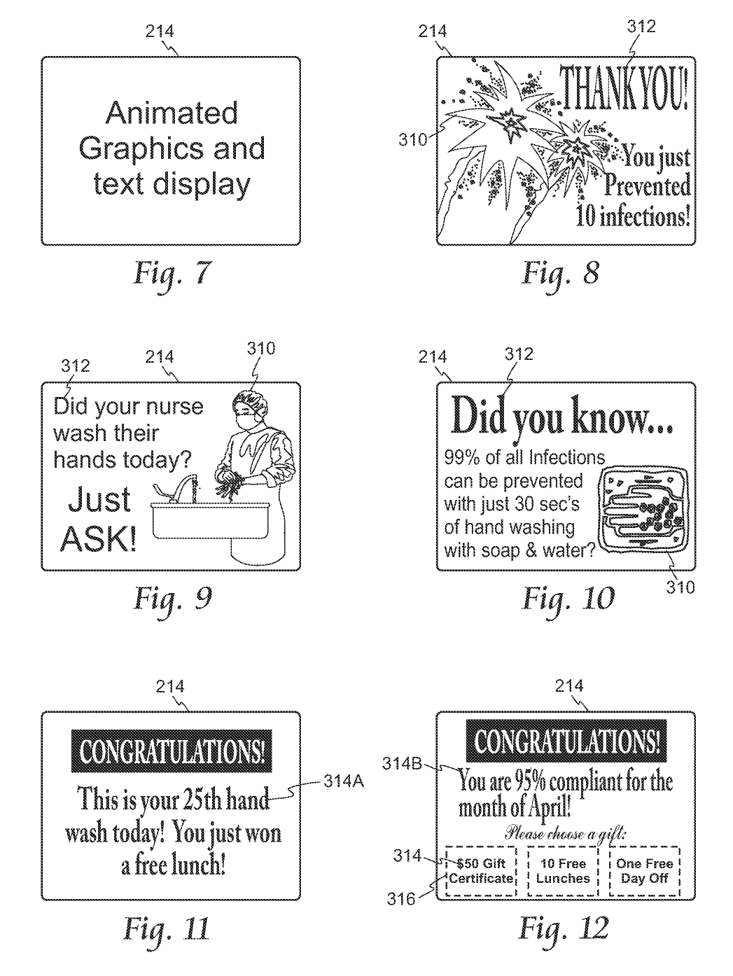

FIG. 7 is an illustration of a visual display produced by the monitor or screen 214 wherein the monitor or screen 214 has the ability to display a plurality of text and/or graphical commendations and data.

FIG. 8 is an illustration of the monitor or screen 214 displaying an animated 310 graphical commendation 312. The goal of the graphical display 310 is to attract the attention of the worker and customer and may be in the form of brilliant color graphics. The goal of the graphical commendation is to positively reinforce the action of using the hand-hygiene station, inform the worker of hand wash statistics, remind the worker to wash their hands, and prompt the customer, such as a hospital patient, to ask if the worker has washed their hands. It should be understood that a plurality of displays can be employed in providing positive reinforcement.

FIG. 9 is an illustration of the monitor or screen 214 displaying information 312 to encourage the hospital patient or customer to become personally involved in hand-hygiene compliance with the goal of reinforcing hand washing actions through reminders by the patient or customer. A graphical display 310 can also be displayed on the monitor 214 with the goal of capturing the interest and attention of the patient or employee.

FIG. 10 is an illustration of the monitor or screen 214 displaying information 312 intended to educate a patient or customer regarding the benefits of hand-hygiene. It should be understood that a plurality of educational displays can be utilized in the education of patients or customers. A graphical display 310 can also be displayed on the monitor 214 with the goal of capturing the interest and attention of the patient or employee.

FIG. 11 is an illustration of the monitor or screen 214 displaying one embodiment of short-term hand wash statistics 314A with the goal of positively reinforcing hand-hygiene actions and informing the worker of their contribution to preventing the spread of infection. Another goal of the display of commendation 314A is to inform the worker of the qualifying reward 314A, further reinforcing the hand-hygiene action.

FIG. 12 is an illustration of the monitor or screen 214 displaying another embodiment of statistical data related to long term hand-hygiene compliance 314B. The goal of the data display 314 is to provide the worker a choice of rewards which can be chosen by pressing the touch-screen “hot-spots” 316. Once a “hot-spot” 316 has been pressed, the chosen reward is issued. For the purpose of this invention, a “hot-spot” 316 is an area of the touch-screen that can sense the touch of a finger and respond by activating an electronic signal.

In one embodiment described herein, verbal or audible commendations are used to positively reinforce hand-hygiene actions. Although audible signals are effective, they may disturb patients trying to sleep. Verbal commendations, on the other hand, can be used in areas such as staff bathrooms, meat packing areas, or other similar rooms that do not require periods of quiet. Visual commendations such as animated graphical displays may be used instead. For example, a visual graphical display may be used at all times but audible signals can be silenced at night. In addition, visual commendations may be used in rooms where voices are unacceptable. Therefore, any combination of visual, audible, vibrating, sensory or any other suitable commendation is within the scope of this invention.

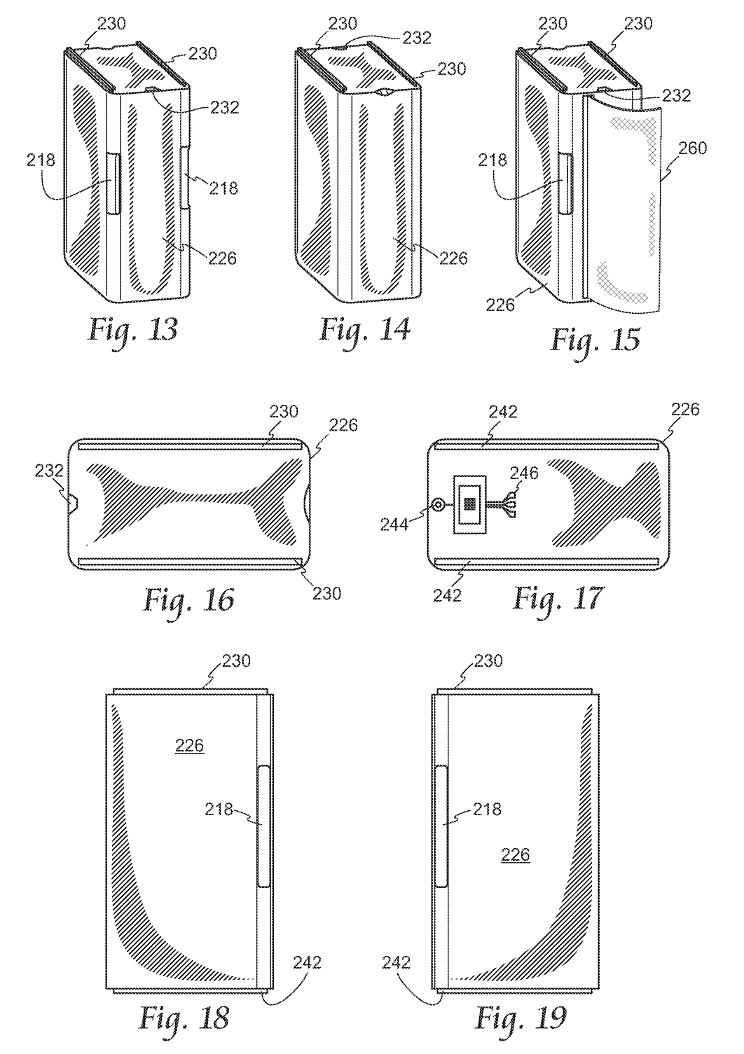

FIG. 13 is an illustration of a hand wash product dispensing bottle 226 that is refillable and traceable by, for example, a unique lot number assigned to the bottle 226. The product dispensing bottle 226 may have grooves 218 that permit a worker to grasp the bottle firmly and pull the bottle towards them self after releasing the bottle from the locking groove 232. The top rails 230 will permit the product dispensing bottle 226 to slide horizontally and fit firmly in place. A dispensing bottle 226 can be manufactured with a clear or frosted plastic that also allows the worker to visually determine the amount of hand wash product in the bottle.

FIG. 14 is yet another illustration of a hand wash product dispensing bottle 226 viewed from the back side. Top rails 230 and a locking groove 232 are shown.

FIG. 15 is an illustration of a hand wash product dispensing bottle 226 of an alternate embodiment. The dispensing bottle 226 may be manufactured to include a towelette 260 dispensing capability that provides hand wash product saturated within the towelette 260. This towelette 260 may be grasped and pulled outward to be used by the worker with the goal of providing an alternate choice of hand wash product and method of decontamination that matches the body chemistry of the worker, for example, by preventing excessive skin drying and cracking.

FIG. 16 is yet another illustration of a hand wash product dispensing bottle 226 viewed from the top. Top rails 230, and a locking groove 232 are shown.

FIG. 17 is yet another illustration of a hand wash product dispensing bottle 226 viewed from the bottom. Bottom rails 242, a dispensing nozzle 244, and electronic contacts 246 are shown. The dispensing bottle 226 may have the capability of contacting the hand wash station through electronic contacts 246 which then send an electronic signal to a nozzle 244 that, in turn, dispenses hand wash product in a predetermined amount.

FIG. 18 is yet another illustration of a hand wash product dispensing bottle 226 viewed from the left side. Top rails 230, bottom rails 242, and one side of the grasping grooves 218 are shown.

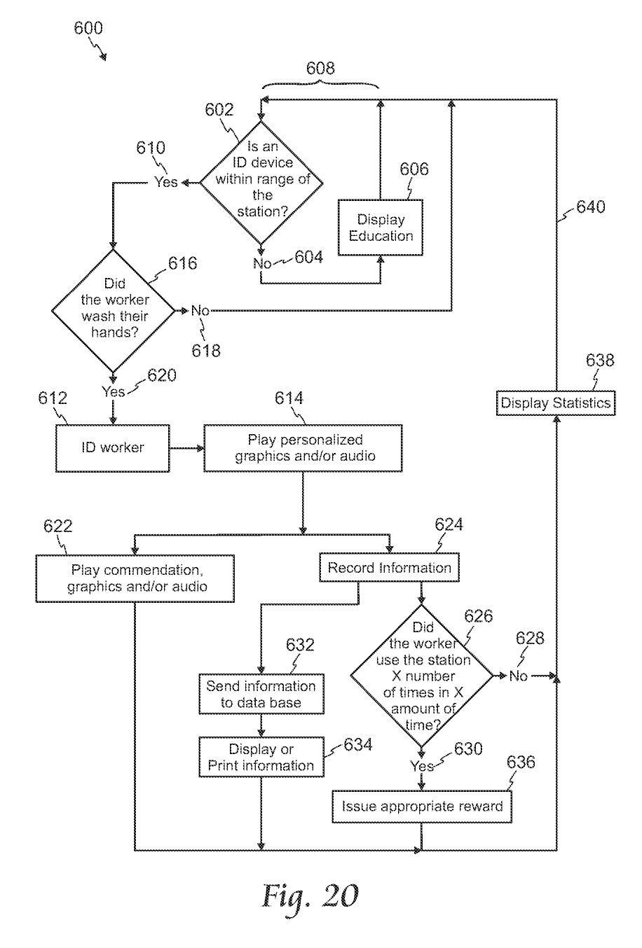

FIG. 19 is yet another illustration of a hand wash product dispensing bottle 226 viewed from the right side. Top rails 230, bottom rails 242, and one side of the grasping grooves 218 are shown.

FIG. 20 is a flowchart 600 illustrating the preferred system of FIGS. 1, 3, 7, 8, 9, 10, 11 and 12. As shown in FIG. 1, a worker and their ID device come within range of a hand wash station. As shown in FIG. 20, the hand wash station ID sensor determines if an ID device is within range 602 of the hand wash station. If no ID device is within range of the station sensor, it is determined that no worker 604 is within range of the hand wash station and educational data, for example, is displayed in a predetermined amount of time and repeated in predetermined intervals 608 to educate customers, patients, or by-standers to name a few. In a preferred embodiment, intervals can be looped and include a plurality of data.

As shown, if it is determined that a worker and their ID device are within range 602 of a sensor, it can be determined that a worker is 610 within range of a hand wash station. It can then be determined if a worker washed their hands 616. If the worker did 620 wash his hands, for example, then the worker will be identified 612 and a personalized message 614 containing graphics and/or audio will be played. If the worker did not 618 use the hand wash station, the system will reset and determine if an ID device is within range 602. Alternatively, the step of determining whether an ID is in range 602, could be activated only after the step of determining that hands have been washed 616 (i.e., no hand washing, no ID). Educational data will again be displayed in a predetermined amount of time and repeated in predetermined intervals 608 to educate, for example, customers, patients, or by-standers.

As shown, after a worker did 620 use the hand wash station and washed his hands, and after the employee identification system 612 has activated and a personalized graphics and/or audio 614 have been played, then a predetermined visual and/or audible commendation will be personalized and played 622. In addition, compliance information such as the number of times the station was used and the worker using the station will be recorded 624 on a computer system data base 632. The recorded information 624 can then be displayed or printed 634 for compliance meetings and other uses.

As shown, after compliance information is recorded 624, the data will be analyzed as to whether the worker used the hand wash station a predetermined number of times or whether the worker used the hand wash station in a predetermined amount of time 626. If it is determined that a worker used the hand wash station a predetermined number of times 630, a predetermined reward 636 will be issued thus positively reinforcing the action. If it is determined that a worker used the hand wash station a predetermined amount of time 630, a predetermined reward 636 will be issued thus positively reinforcing the action.

As shown, if it is determined that a worker did not 628 use the hand wash station a predetermined number of times 626, and if it is determined that a worker did not 628 use the hand wash station a predetermined amount of time 626, personalized statistics relating to the number of times and the amount of time the hand wash station was and was not used will be displayed 638 and no reward 636 will be issued.

As shown, after it is determined that a worker qualifies for a reward 636 or does not 628, the system will reset and loop back to the ID sensor 602 and display educational information 606.

It is to be understood that a plurality of delays and resets can be implemented throughout the preferred embodiment. For example, in a preferred embodiment, if it was determined that a worker was in range of the ID device 610 and did not wash their hands 618, after the expiration of a predetermined amount of time, educational data 606 would be displayed.

It is also to be understood that software can manage the hand wash system and could be configured 600 as shown and described above.

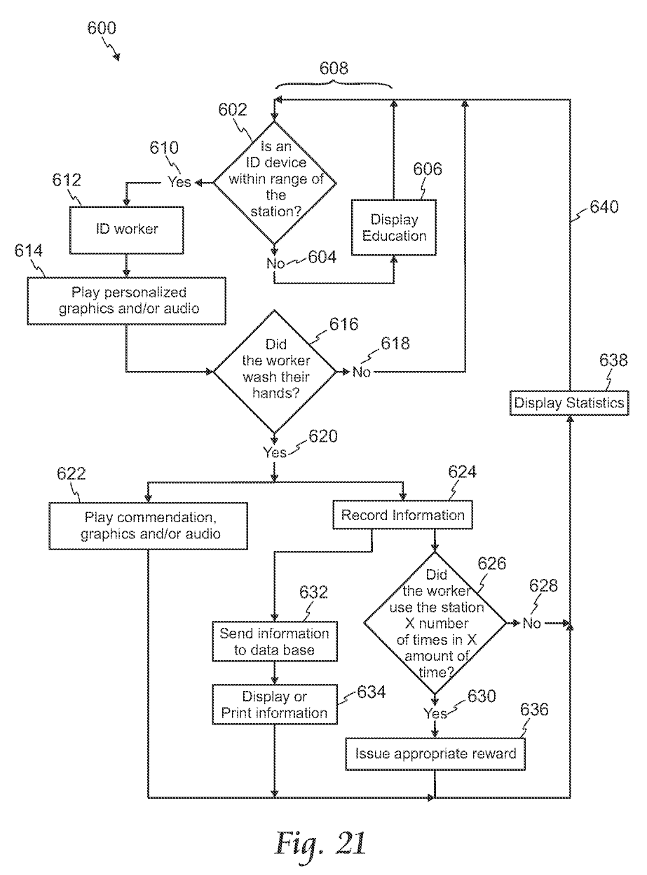

FIG. 21 is a flowchart 600 illustrating an alternate embodiment of the system of FIGS. 1, 3, 7, 8, 9, 10, 11 and 12. As shown in FIG. 1, a worker and their ID device come within range of a hand wash station. As shown in FIG. 21, the hand wash station ID sensor determines if an ID device is within range 602 of the hand wash station. If no ID device is within range of the station sensor, it is determined that no worker 604 is within range of the hand wash station and educational data, for example, is displayed in a predetermined amount of time and repeated in predetermined intervals 608 to educate customers, patients, or by-standers to name a few. In a preferred embodiment, intervals can be looped and include a plurality of data.

As shown, if it is determined that a worker and their ID device are within range 602 of a sensor, it will be determined that a worker is 610 within range of a hand wash station. Once positively identified 612, a personalized message 614 containing graphics and/or audio will be played with the purpose of personalizing the message. If the worker did not use the hand wash station 618, the system will reset and determine if an ID device is within range 602. Educational data will again be displayed in a predetermined amount of time and repeated in predetermined intervals 608 to educate, for example, customers, patients, or by-standers.

As shown, after a worker did 620 use the hand wash station and washed their hands, and after the employee identification system 612 has activated and a personalized graphics and/or audio 614 have been played, then a predetermined visual and/or audible commendation will be personalized and played 622. In addition, compliance information such as the number of times the station was used and the worker using the station will be recorded 624 on a computer system data base 632. The recorded information 624 can then be displayed or printed 634 for compliance meetings and other uses.

As shown, after compliance information is recorded 624, the data will be analyzed as to whether the worker used the hand wash station a predetermined number of times or whether the worker used the hand wash station in a predetermined amount of time 626. If it is determined that a worker used the hand wash station a predetermined number of times 630, a predetermined reward 636 will be issued thus positively reinforcing the action. If it is determined that a worker used the hand wash station a predetermined amount of time 630, a predetermined reward 636 will be issued thus positively reinforcing the action.

As shown, if it is determined that a worker did not 628 use the hand wash station a predetermined number of times 626, and if it is determined that a worker did not 628 use the hand wash station a predetermined amount of time 626, personalized statistics relating to the number of times and the amount of time the hand wash station was and was not used will be displayed 638 and no reward 636 will be issued.

As shown, after it is determined that a worker qualifies for a reward 636 or does not 628, the system will reset and loop back to the ID sensor 602 and display educational information 606.

It is to be understood that a plurality of delays and resets can be implemented throughout the preferred embodiment. For example, in a preferred embodiment, if it was determined that a worker was in range of the ID device 610 and did not wash their hands 618, after the expiration of a predetermined amount of time, educational data 606 would be displayed.

It is also to be understood that software can manage the hand wash system and could be configured 600 as shown and described above.

Although the invention has been described in detail with reference to one or more particular preferred embodiments, persons possessing ordinary skill in the art to which this invention pertains will appreciate that various modifications and enhancements may be made without departing from the spirit and scope of the claims that follow. For example, simple pre-punched lapel pins may be substituted for the customer education/prompts that remind workers to wash their hands. Likewise, although a hospital-patient environment has been described herein, the method and system is also applicable to other environments where hygiene is crucial such as food service or day care facilities. Given the above disclosure, many other features, modifications and improvements will become apparent to one skilled in the art.

What is claimed is:

1. An infection-reduction system for use in the field of health-care and other hygiene critical fields, the infection-reduction system comprising,
a hand-hygiene station,
the hand-hygiene station comprising a hand-hygiene identification system, an employee-identification system, and a reward system, wherein the employee-identification system activates only after the hand-hygiene identification system indicates that hands are being treated by an employee and wherein the reward system assigns a reward to the employee for using the hand-hygiene station.

2. A method for reducing infection in the field of health care and other hygiene critical fields, the method comprising the steps of:
(a) determining whether use of a hand-hygiene station has been used;
(b) if the hand-hygiene station has been used, determining whether an identifiable person is in range of the hand-hygiene station; and,
(c) recording the use of the hand-hygiene station by the identifiable person.

3. The method of claim 2, wherein the step of recording is performed by a computer.

4. The method of claim 2, further comprising the step of rewarding the user of the hand-hygiene station.

5. The method of claim 4, wherein the step of rewarding is displayed on a monitor or screen.

6. The method of claim 4, wherein the step of rewarding involves an audible commendation.

7. The method of claim 4, wherein the step of rewarding further comprises checking the history of use of hand-hygiene station use and determining if a larger reward has been earned.

8. A system for a third party to visually and audibly observe use of a hand-hygiene station by a person in a hygiene critical field comprising:
a visual display of a predetermined graphical animation sequence, wherein the visual display is located in the direct line of sight of an third-party to a hand-hygiene transaction,
and a means for enabling the third party to prompt or question the hand-hygiene practices of a party to the hand-hygiene transaction before services are rendered to the third party.

9. The system of claim 8, further comprising a computer connected to the system to store information about the hand-hygiene transaction.
